(19) United States
(12) Patent Application Publication
(10) Pub. No.: US 2006/0007622 A1
(43) Pub. Date: Jan. 12, 2006

(54) Car power source apparatus

(76) Inventors: Kimihiko Furukawa, Kakogawa-city (JP); Masahiko Hashimoto, Kasai-city (JP)

Correspondence Address: WENDEROTH, LIND & PONACK, L.L.P., 2033 K STREET N. W., SUITE 800, WASHINGTON, DC, 20006-1021, US

(21) Appl. No.: 11/172,823

(22) Filed: Jul. 5, 2005

(30) Foreign Application Priority Data
Jul. 6, 2004 (JP) 199860/2004

(51) Int. Cl. H01H 73/00

(52) U.S. Cl. 361/115

(57) ABSTRACT

The car power source apparatus is provided with a driving battery 1 having a plurality of battery modules 2 connected in series, contactors (electric vehicle battery relay contacts) 6 connected to the output side of the driving battery 1, a control circuit 7 to control the contactors 6 on and off, and a voltage detection circuit 3 to detect voltage of the battery modules 2 of the driving battery 1. Both the control circuit 7 and voltage detection circuit 3 are provided with output voltage detection circuits 7a, 3a to detect contactor 6 output voltage. If the output voltage detection circuit 7a in the control circuit 7 cannot detect contactor 6 output voltage, the output voltage detection; circuit 3a in the voltage detection circuit 3 detects contactor 6 output voltage to determine if a contactor 6 is fused closed.

### BACKGROUND OF THE INVENTION

This invention relates to a car power source apparatus provided with a circuit to detect if a contactor has fused closed; wherein contactors (electric vehicle battery relay contacts) are connected to the output side of a driving battery that supplies power to an electric motor that drives the car.

A power source apparatus intended for a car comprises a driving battery having high voltage output. This power source apparatus has contactors connected to its output side. The contactors are switched off to cut-off current flow when the ignition switch is off and the car is stopped, or in case of an abnormality. It is particularly important for the contactors to reliably cut-off current flow when an abnormality occurs. This is to insure sufficiently safe conditions when a car crash occurs or maintenance is performed. However, since driving battery output current flows through the contactors, very large currents flow through them. Further, since a large storage capacitor is connected in parallel with the output side of the driving battery, extremely high currents flow through the contactors when that capacitor cannot be charged in a normal manner. High current flow through the contactors is a cause of the contactor's contact points fusing together. Since driving battery output cannot be cut-off if contactor contact points fuse closed, it is important to reliably detect if those contact points have fused closed.

### SUMMARY OF THE INVENTION

To implement this, a car power source apparatus which detects a fused closed contactor has been developed (Japanese Patent Application Disclosure HEI 8-182115, 1996).

The power source apparatus cited in this prior art disclosure detects terminal voltage of an auxiliary battery when the main contactors are cut-off to detect if a contactor has fused closed. The auxiliary battery is charged by the driving battery via a DC/DC converter. If a contactor becomes fused closed, the DC/DC converter operates, the auxiliary battery is charged by the driving battery, and auxiliary battery voltage increases. If contactors cut-off normally, the DC/DC converter does not operate, the auxiliary battery is not charged, and voltage decreases. Therefore, if a contactor has fused closed, it can be detected by auxiliary battery voltage.

A power source apparatus of this configuration can detect if a contactor has fused closed as long as all circuits operate normally. However, if a circuit somewhere, such as the DC/DC converter, should fail, it becomes impossible to reliably detect fusing of a contactor. For example, if the DC/DC converter fails to function, or if the DC/DC converter output voltage drops, auxiliary battery voltage will drop and contactors will be mistakenly judged to be cut-off. In a power source apparatus on board a car, it is particularly important, for example, to reduce the effects of a single failure, and to the degree possible, minimize the negative impact of any malfunction. This is because even if the car is in a condition to drive, it can become inoperable due to some circuit failure, or even if the car is not in a condition to drive, it may be driven resulting in some negative impact. This drawback can be eliminated by providing two redundant circuits for every circuit, and switching to another circuit if failure occurs. However, from the fact that this doubles manufacturing cost, it is entirely impractical.

The present invention was developed with the object of solving these types of problems. Thus it is a primary object of the present invention to provide a car power source apparatus that can reliably detect a contactor fusing closed even if some circuit has failed. Further, another object of the present invention is to provide a car power source apparatus wherein even if a voltage detection circuit falls, it is supplemented by another voltage detection circuit to measure voltage.

The car power source apparatus of the present invention is provided with a driving battery 1 having a plurality of battery modules 2 connected in series, contactors 6 connected to the output side of the driving battery 1, a control circuit 7 to control the contactors 6 on and off, and a voltage detection circuit 3 to detect voltage of the battery modules 2 of the driving battery 1. The control circuit 7 is provided with a first output voltage detection circuit 7a to detect contactor 6 output voltage. The voltage detection circuit 3 is provided with an input voltage detection circuit 3b to detect contactor 6 input voltage, and a second output voltage detection circuit 3a to detect contactor 6 output voltage. In this power source apparatus, when the control circuit 7 has cut-off the contactors 6, the first output voltage detection circuit 7a detects output voltage to determine if a contactor 6 is fused closed. If the condition of the first output voltage detection circuit 7a does not allow it to detect contactor 6 output voltage, the second output voltage detection circuit 3a in the voltage detection circuit 3 detects contactor 6 output voltage to determine if a contactor 6 is fused closed.

The voltage detection circuit 3 can be provided with a multiplexer 4 to switch and detect voltage of a plurality of battery modules 2. In this voltage detection circuit 3, input and output sides of the contactors 6 are connected to specific channels of the multiplexer 4 to detect contactor 6 input and output voltage.

The voltage detection circuit 3 can be provided with a plurality of voltage detection units 3A. Each voltage detection unit 3A is provided with a second output voltage detection circuit 3a to detect contactor 6 output voltage and an input voltage detection circuit 3b to detect contactor 6 input voltage, and each voltage detection unit 3A detects contactor 6 output and input voltage. Further, each voltage detection unit 3A can be provided with a multiplexer 4 to switch and detect voltage of a plurality of battery modules 2, and input and output sides of the contactors 6 can be connected to specific channels of a multiplexer 4 to detect contactor 6 input and output voltage.

In the car power source apparatus described above, the control circuit is provided with a first output voltage detection circuit to detect contactor output voltage, and the voltage detection circuit is provided with an input voltage detection circuit to detect contactor input voltage and a second output voltage detection circuit to detect contactor output voltage. Therefore, even if the first output voltage detection circuit of the control circuit cannot detect contactor output voltage, the second output voltage detection circuit of the voltage detection circuit can detect contactor output voltage, and it is possible to reliably determine if a contactor is fused closed from its input and output voltage.

Further, the voltage detection circuit can be provided with a plurality of voltage detection units, and each voltage detection unit can detect contactor output voltage and input voltage. In such an apparatus, if the condition of the first output voltage detection circuit of the control circuit becomes unable to detect output voltage, a fused closed contactor can be detected from input and output voltage detected by the voltage detection circuit. If any voltage detection unit malfunctions and becomes unable to detect voltage, input voltage can be detected by a properly operating voltage detection unit, output voltage can be detected by the control circuit, and a fused closed contactor can be reliably detected.

Another car power source apparatus of the present invention is provided with a driving battery 1 having a plurality of battery modules 2 connected in series, contactors 6 connected to the output side of the driving battery 1, a control circuit 7 to control the contactors 6 on and off, and a voltage detection circuit 3 to detect voltage of the battery modules 2 of the driving battery 1. The driving battery 1 is made up of a plurality of battery blocks 1A, the voltage detection circuit 3 is made up of a plurality of voltage detection units 3A, voltage detection units 3A are connected to battery blocks 1A, and one voltage detection unit 3A detects the voltage of battery modules 2 that form one battery block 1A. Each voltage detection unit 3A is provided with a multiplexer 4 to switch to the battery module 2 for voltage detection, and a voltage detection section 5 to detect the voltage of the connection node switched to by the multiplexer 4. The multiplexer 4 switches battery modules 2 to detect the voltage of each battery module 2. In addition, the input side of the multiplexer 4 of each voltage detection unit 3A is connected to input and output sides of the contactors 6, and contactor 6 input and output voltage is detected by each voltage detection unit 3A.

In the car power source apparatus described above, a voltage detection circuit made up of a plurality of voltage detection units is connected to a driving battery made up of a plurality of battery blocks, and one voltage detection unit detects the voltage of each battery module comprising one battery block. Since each voltage detection unit detects contactor input and output voltage, a fused closed contactor can be reliably detected by detecting input and output voltage even if a voltage detection unit fails.

Still another car power source apparatus of the present invention is provided with a driving battery 1 having a plurality of battery modules 2 connected in series, and a voltage detection circuit 3 to detect voltage of the battery modules 2 of the driving battery 1. The driving battery 1 is made up of a plurality of battery blocks 1A, the voltage detection circuit 3 is made up of a plurality of voltage detection units 3A, voltage detection units 3A are connected to battery blocks 1A, and one voltage detection unit 3A detects the voltage of battery modules 2 that form one battery block 1A. Each voltage detection unit 3A is provided with a multiplexer 4 to switch to the battery module 2 for voltage detection, and a voltage detection section 5 to detect the voltage of the connection node switched to by the multiplexer 4. The multiplexer 4 switches battery modules 2 to detect the voltage of each battery module 2. In addition, the input side of the multiplexer 4 of each voltage detection unit 3A is connected to the output side of the driving battery 1, and the total voltage of the driving battery 1 is detected by each voltage detection unit 3A.

Further, the car power source apparatus described above has the characteristic that even if a voltage detection unit malfunctions and cannot detect voltage, the total voltage of the battery block connected to that voltage detection unit can be detected. This is because total voltage of the driving battery can be detected by voltage detection units that have not malfunctioned, and the voltage of battery blocks connected to unbroken voltage detection units can be detected as well. Consequently, even if one of the voltage detection units malfunctions, total voltage of the battery block of that voltage detection unit can be detected by another voltage detection unit, and battery status can be monitored.

The above and further objects and features of the invention will more fully be apparent from the following detailed description with accompanying drawings.

### BRIEF DESCRIPTION OF THE DRAWINGS

FIG. 1 is an abbreviated structural diagram of one embodiment of a car power source apparatus of the present invention.

FIG. 2 is a circuit diagram of the car power source apparatus shown in FIG. 1.

FIG. 3 is an abbreviated structural diagram of another embodiment of a car power source apparatus of the present invention.

### DETAILED DESCRIPTION OF THE PREFERRED EMBODIMENTS

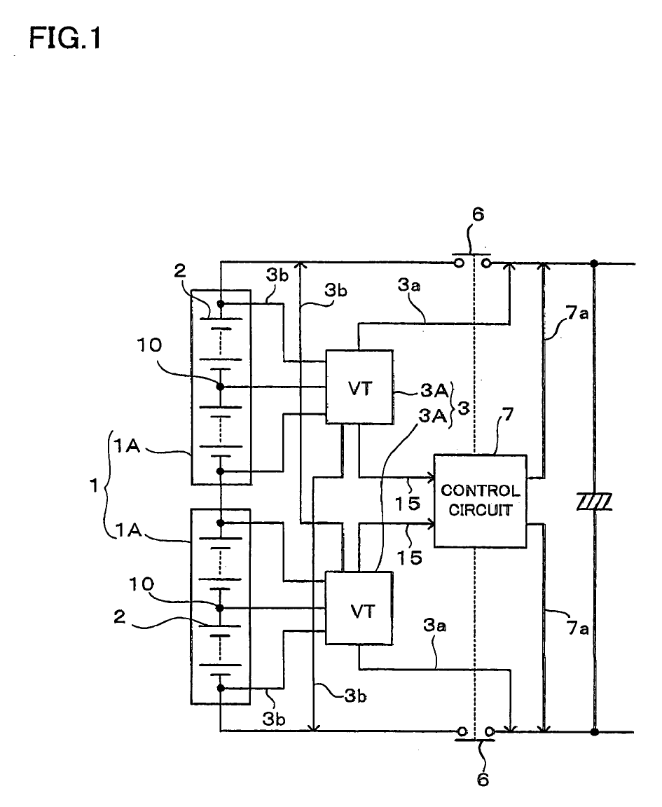

The car power source apparatus shown in FIG. 1 is provided with a driving battery 1 to supply electric power to an onboard electric motor (not illustrated) that drives the car, contactors 6 connected to the output side of the driving battery 1, a control circuit 7 to control the contactors 6 on and off, and a voltage detection circuit 3 to detect voltage of battery modules 2 of the driving battery 1.

The driving battery 1 has a plurality of battery modules 2 connected in series to increase output voltage. The power source apparatus of the figure has a driving battery 1 made up of two battery blocks 1A, and all the battery modules 2 are separated into these two battery blocks 1A. To detect voltage of battery modules 2 comprising these two battery blocks 1A, the voltage detection circuit 3 is made up of two voltage detection units 3A. Each voltage detection unit 3A is connected to a battery module 11A, and one voltage detection unit 3A detects the voltage of battery modules 2 in one battery block 1A. Although the power source apparatus of the figure is made up of: two groups of battery blocks 1A and voltage detection units 3A, the power source apparatus can also be made up of three or more battery blocks and voltage detection units.

The driving battery 1 has a plurality of battery modules 2 connected in series. However, a driving battery 1 with fifty battery modules 2 connected in series for example, is divided into two equal battery blocks 1A of twenty five battery modules 2 each, or it is divided into battery blocks 1A of unequal number such as twenty four and twenty six battery modules 2 for a total of fifty battery modules 2. A battery module 2 has a plurality of rechargeable batteries connected in series. For example, a battery module 2 has five nickel hydrogen batteries connected in series. In this case, the driving battery 1 has altogether two hundred and fifty nickel hydrogen batteries connected in series for an output voltage of 300V. However, a battery module does not necessarily have five batteries connected in series, and it may have four rechargeable batteries or less, or six rechargeable batteries or more connected in series. In addition, rechargeable batteries are not limited to nickel hydrogen batteries and other types of batteries that can be recharged, such as lithium ion rechargeable batteries or nickel cadmium batteries may also be used as the rechargeable batteries. Further, a driving battery 1 does not necessarily have fifty battery modules connected in series, and it may have a fewer number of battery modules or a greater number of battery modules connected in series.

In a power source apparatus with fifty series connected battery modules 2 divided into two battery blocks 1A and the voltage of battery modules 2 in the two battery blocks 1A detected by two voltage detection units 3A, one voltage detection unit 3A detects the voltage of twenty four to twenty six battery modules 2.

In the voltage detection circuit 3, which is made up of two voltage detection units 3A, each voltage detection unit 3A is provided with a multiplexer 4 to switch to a battery module 2 for voltage detection, and a voltage detection section 5 to detect the voltage of the connection node selected by multiplexer 4 switching. The voltage detection unit 3A detects the voltage of each battery module 2 selected by multiplexer 4 switching.

Multiplexers 4 switch the connection node for voltage detection to sequentially detect the voltage of all battery modules 2. Therefore, the output side of a multiplexer 4 is connected to the input side of a voltage detection section 5, and the multiplexer 4 sequentially switches battery modules 2 for detection by the voltage detection section 5.

In general, an integrated circuit (IC) housing a multiplexer 4 has a number of channels that increases as a power of two, such as 2 channels, 4 channels, 8 channels, 16 channels, 32 channels, or 64 channels. To switch to, and detect the voltage of all battery modules 2 comprising one battery block 1A, a multiplexer 4 is used that has more channels than the number of battery modules 2 included in that battery block 1A. For example, a voltage detection unit 3A, which detects the voltage of twenty four to twenty six battery modules 2, uses a 32 channel multiplexer 4. Therefore, the number of multiplexer 4 channels is almost never the same as the number of battery modules 2, and the number of multiplexer 4 channels is greater than the number of battery modules 2. As a result, there are unused multiplexer 4 channels.

For example, in the case of a 32 channel multiplexer 4 that switches twenty four to twenty six battery modules 2, there are six to eight multiplexer 4 channels that are not used to switch battery modules 2.

In the power source apparatus of the figures, extra multiplexer 4 channels, which are not used for battery module 2 voltage detection, are used to detect input and output voltage of the contactors 6. Further, voltage detection sections 5 connected to multiplexers 4 serve the additional function of detecting contactor 6 input and output voltage. Therefore, this power source apparatus requires no additional special purpose detection circuitry to detect contactor 6 input and output voltage. Further, a voltage detection circuit 3, which uses surplus multiplexer 4 channels not used to detect battery module 2 voltage to detect contactor 6 input and output voltage, does not require any additional special purpose circuitry, nor does it need to increase the number of electronic parts to implement that circuitry.

The multi-channel input terminals of a multiplexer 4 are connected to the connection nodes of the series connected battery modules 2. Connection node voltages can give the voltage at both terminals of each battery module 2. Consequently, voltage of a battery module 2 is detected from the difference in connection node voltage at both its terminals. Further, to detect contactor 6 input and output voltage, input terminals of remaining surplus channels of the multiplexers 4 are connected to input and output sides of the contactors 6.

In the power source apparatus of FIG. 1, the control circuit 7 detects contactor 6 output voltage, and the two voltage detection units 3A detect contactor 6 input voltage and output voltage. Specifically, contactor 6 input and output voltage is detected by three voltage detection circuits. Contactor 6 output voltage is detected by the control circuit 7 and two voltage detection units 3A, and contactor input voltage is detected by each voltage detection unit 3A.

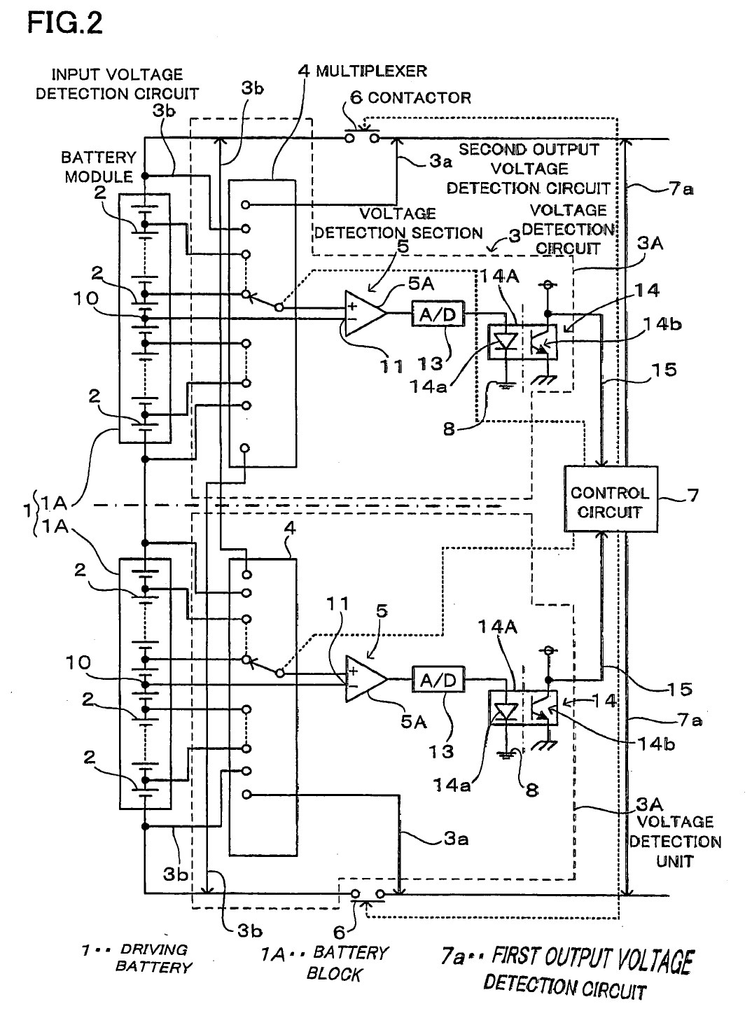

This power source apparatus can detect a contactor 6 fusing closed even if one of three voltage detection circuits becomes unable to detect voltage. For example, if the control circuit 7 becomes unable to detect contactor 6 output voltage, the two voltage detection units 3A can detect contactor 6 output voltage as well as contactor 6 input voltage. If one of the voltage detection units 3A becomes unable to detect voltage, contactor 6 output voltage can be detected by the control circuit 7, and contactor 6 input voltage can be detected by the other voltage detection unit 3A. Each voltage detection unit 3A has its extra multiplexer 4 channel input terminals connected to positive and negative input sides of the contactors 6 to allow contactor 6 input voltage detection. Therefore, if either of the voltage detection units 3A becomes unable to detect voltage, contactor 6 input voltage can be detected by the other voltage detection unit 3A. However, contactor 6 output voltage is detected by both voltage detection units 3A. In proper operating condition. This is because the positive side voltage detection unit 3A detects only positive side contactor 6 output voltage, and the negative side voltage detection unit 3A detects only negative side contactor 6 output voltage. Since contactor 6 output voltage is detected by both the voltage detection circuit 3 and the control circuit 7, contactor 6 output voltage can be detected by the control circuit 7 even if one of the voltage detection units 3A becomes unable to detect voltage. Therefore, even if one of the voltage detection units 3A becomes unable to detect voltage, contactor 6 output voltage is detected by the control circuit 7, and contactor 6 input voltage is detected by the other unbroken voltage detection unit 3A. Consequently, in the power source apparatus of FIGS. 1 and 2, even if one of the three circuits, which are the two voltage detection units 3A and the control circuit 7, becomes unable to detect voltage, contactor 6 input and output voltage can be detected by the remaining two voltage detection circuits. A fused closed contactor 6 can be determined by detecting contactor 6 input and output voltage. This type of fusing is determined by comparing contactor 6 input and output voltage in the following manner. When a contactor 6 is off, if it is normal (not fused closed), input and output voltage will not be equal, and if it is fused closed, input and output voltage will be approximately equat. Specifically, contactor 6 input and output voltage are compared, if they are within a specific range (output voltage relative to input voltage within a maximum voltage criteria considering measurement error±approximately 20%), the contactor 6 is judged closed, and if the specific range is exceeded, the contactor 6 is judged open.

In the power source apparatus of FIG. 2, the driving battery 1 is divided into two battery blocks 1A on positive and negative sides, the voltage detection circuit 3 is divided into a positive side voltage detection unit 3A and a negative side voltage detection unit 3A, surplus channels of the positive side voltage detection unit 3A are connected to contactor 6 positive side output and negative side input, and surplus channels of the negative side voltage detection unit 3A are connected to contactor 6 negative side output and positive side input. Therefore, the positive side voltage detection unit 3A can detect contactor 6 positive side and negative side input voltage, and positive side output voltage. The negative side voltage detection unit 3A can detect contactor 6 positive side and negative side input voltage, and negative side output voltage. Contactor 6 output voltage is detected as a positive side output voltage and a negative side output voltage. The voltage detection units 3A of the figure detect both positive and negative side contactor 6 input voltage, but only detect voltage on one side of positive, and negative side contactor 6 outputs. However, although not illustrated, surplus multiplexer channels can also be connected to contactor positive output and negative output sides to allow voltage detection units to detect contactor output voltage on both positive and negative sides.

A voltage detection section 5 is a difference amplifier 5A which detects the difference in voltage input to its pair of input terminals. A voltage detection section 5 of the figure has one input terminal designated as a reference input terminal 11, and this reference input terminal 1 is connected to a driving battery 1 midpoint reference node 10. A midpoint reference node 10 is preferably the midpoint voltage of the plurality of battery modules 2 comprising one of the two battery blocks 1A of the driving battery 1, and this midpoint reference node 10 is connected to the reference input terminal 11. However, a midpoint reference node connected to a reference input terminal does not necessarily have to be at the midpoint voltage. A point offset from the midpoint voltage can also be used as a midpoint reference node, and the reference input terminal of the voltage detection section can be connected to that point. The other input terminal of a voltage detection section 5 is connected to the output side of a multiplexer 4. A voltage detection section 5 made up of a difference amplifier 5A has a midpoint reference node 10 connected to its negative side input, which is the reference input terminal 11, and a multiplexer 4 connected to its positive side input. However, a voltage detection section, which is a difference amplifier, can also have its positive and negative side inputs reversed to invert its output.

Voltage detection section 5 output is converted to a digital signal by an analog-to-digital (A/D) converter, the output is isolated by a isolation circuit 14, and transmitted via a signal line 15. An optically coupled semiconductor switch 14A, such as a photo-relay made up of a light emitting diode (LED) 14a optically coupled to a photo-transistor 14b, is used as an isolation circuit 114. A signal transmitting transformer separated from ground can also be used as an isolation circuit.

In the voltage detection circuit 3 described above, a multiplexer 4 switches at a fixed sampling period, and each connection node voltage is detected by a voltage detection section 5. The voltage of each battery module 2 is detected from the voltage difference at adjacent connection nodes. Namely, battery module 2 voltage is detected from the voltage difference between its two terminals. In addition to detecting battery module 2 connection node voltage, a multiplexer 4 and voltage detection section 5 also detect contactor 6 input and output voltage. Connection node voltage, contactor 6 input voltage, and contactor 6 output voltage detected by a voltage detection section 5 are input to the control circuit 7 via signal lines 15. From the input voltages, the control circuit 7 detects voltage of each battery module 2 and contactor 6 input and output voltage. In addition, the control circuit 7 controls multiplexer 4 channel switching, is synchronized with multiplexer 4 switching, detects the voltage of specified battery modules 2 from the detected voltages, and detects contactor 6 input and output voltage.

The control circuit 7 also controls the contactors 6 on and off. With contactors 6 in the off state, the control circuit 7 also judges from contactor 6 input and output voltage whether contactors 6 are properly cutting-off current or not. If contactors 6 are properly switched off, output voltage does not correspond to input voltage. The control circuit 7 controls contactors 6 to the off state, detects input and output voltage, and judges whether a contactor 6 is fused closed as described above. Whether a contactor 6 is fused closed or not can also be judged as follows. With contactors 6 in the off state, the control circuit compares input voltage and output voltage with set values stored in memory to determine if a contactor is fused closed. In this situation, if the difference between input and output voltage is greater than the set value, contactors 6 are judged to be properly cutting-off current and not fused closed. If the difference between input and output voltage is less than the set value, contactors 6 are judged to be fused closed. If contactors 6 are judged to be fused closed, a warning signal is sent to the main system of the car, and the following actions are subsequently taken. If a fused closed judgment is made, car driving is continued. In a stopped car, if the key is turned off (key-off), the car will not start (no re-start) next time the key is turned on (key-on). Judgment of a fused closed contactor 6 only occurs during periods when contactors 6 are open. Therefore, since contactors 6 normally remain on during driving, the fused contactor 6 detection function has no effect on a car in the process of being driven. This type of fused contactor 6 detection can take place when contactors 6 are controlled from a closed state to an open state. Specifically, fused contactor 6 detection takes place at times such as when car driving is finished and the key is turned off, of when a battery system abnormality occurs and battery use is discontinued. The set value for comparison is a value such that input and output voltage difference is less than the set value when a contactor 6 is fused closed, input and output voltage difference is greater than the set value when a contactor 6 is not fused closed and switches off properly, and the set value is stored in a memory circuit (not illustrated) in the control circuit 7.

In the power source apparatus of the figures, both the control circuit 7 and voltage detection circuit 3 detect contactor 6 output voltage. The circuit which detects contactor 6 output voltage in the control circuit 7 is the first output voltage detection circuit 7a. The circuit which detects contactor 6 output voltage in the voltage detection circuit 3 is the second output voltage detection circuit 3a. In the power source apparatus of FIGS. 1 and 2, two voltage detection units 3A detect output voltage at positive and negative side contactors 6 to detect total contactor 6 output voltage. Consequently, the second output voltage detection circuit 3a of this power source apparatus is made up of two voltage detection units 3A. Since the voltage detection circuit 3 is made up of two voltage detection units 3A in the power source apparatus shown in these figures, the second output voltage detection circuit 3a is also made up of two voltage detection units 3A. However, in the power source apparatus of the present invention, the second output voltage detection circuit can also be made up of a single voltage detection circuit or three or more voltage detection units.

In the power source apparatus of FIG. 2, although the positive side voltage detection unit 3A detects positive side contactor 6 output voltage and the negative side voltage detection unit 3A detects negative side output voltage, a voltage detection unit on only one side can also detect both positive side and negative side contactor output voltage. Such a voltage detection unit has its surplus channel input terminals connected to positive and negative side contactor outputs.

Further, the voltage detection circuit 3 is provided with input voltage detection circuits 3b to detect contactor 6 input voltage. In the voltage detection circuit 3 of the figures, each voltage detection unit 3A detects contactor 6 input voltage by detecting positive side input voltage and negative side input voltage. Consequently, even if the voltage detection unit 3A on one side becomes unable to detect voltage, the voltage detection unit 3A on the other side can detect contactor 6 input voltage.

In addition, each voltage detection unit 3A detects the voltage of each battery module 2 connected to it. If one voltage detection unit 3A malfunctions and becomes unable to detect voltage, the other voltage detection unit 3A detects the total voltage of the battery block 1A connected to the failed voltage detection unit 3A. For example, if the positive side voltage detection unit 3A falls and becomes unable to detect the voltage of battery modules 2 in the positive side battery block 1A, the negative side voltage detection unit 3A detects the total voltage of the positive side battery block 1A. A power source apparatus, which can detect total battery block 1A voltage when individual battery module 2 voltage cannot be detected, allows the car to be driven while monitoring the driving battery 1, even when one voltage detection unit 3A has failed. This is because even if the status of each battery module 2 cannot be detected, the status of the battery block 1A, as a unit, can be detected. In the voltage detection circuit 3 of FIG. 2, surplus channels of the multiplexers 4 are connected to positive and negative side contactor 6 inputs to detect positive and negative side input voltage with one voltage detection unit 3A. Therefore, any voltage detection unit 3A is able to detect total driving battery 1 voltage. Since total driving battery 1 voltage can be detected, and since the voltage of the battery block 1A connected to the unbroken voltage detection unit 3A can be detected, the total voltage of the battery block 1A connected to the failed voltage detection unit 3A can also be detected. Consequently, even if one voltage detection unit 3A falls, the other voltage detection unit 3A can detect total voltage, and the car can be driven while monitoring battery status.

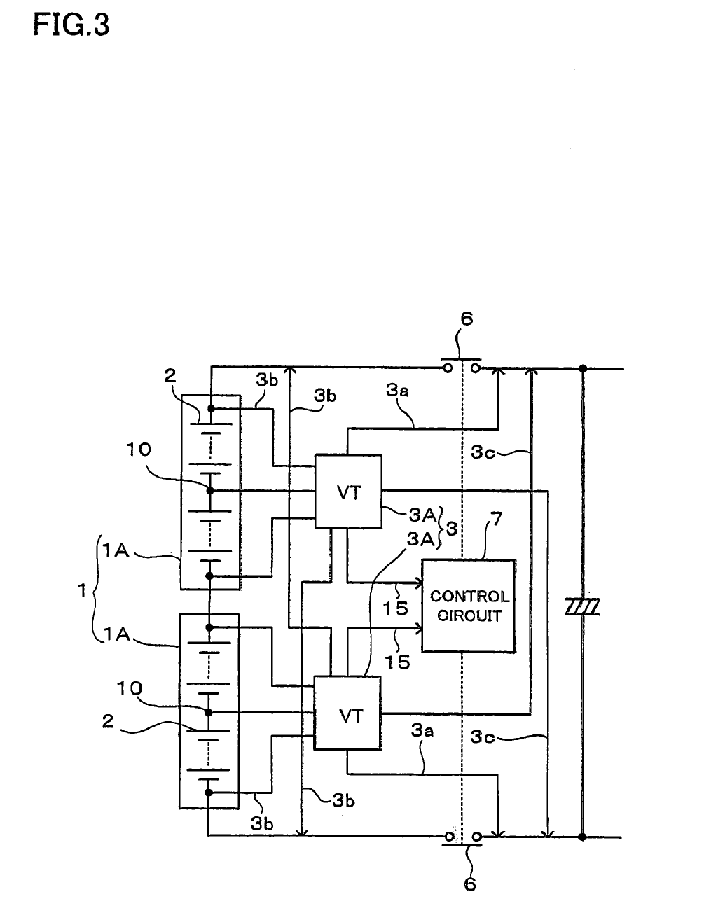

Another embodiment of the present invention is shown in FIG. 3. In the embodiment of this figure, elements that are the same as the embodiment described above are given the same label and their description is omitted. In FIG. 3, and in contrast to the embodiment of FIGS. 1 and 2, a third output voltage detection circuit 3c is provided in each voltage detection unit 3A to detect contactor 6 output voltage on the opposite polarity side. Although rot illustrated, measurement via this third output voltage detection circuit 3c is enabled in the same manner as in FIG. 2, through a multiplexer 4 input terminal.

This makes the first output voltage detection circuit 7a of FIG. 1 unnecessary. In this embodiment, as in the previous embodiment described above, even if one voltage detection unit 3A fails, the total voltage of the battery block 1A connected to the broken voltage detection unit 3A can be detected. Therefore, even if one voltage detection unit 3A falls, the other voltage detection unit 3A can detect total voltage (contactor 6 input voltage), and the car can be driven while monitoring battery status. Further, since the unbroken voltage detection unit 3A is provided with a third output voltage detection circuit 3c to detect contactor 6 output voltage on the opposite polarity side, contactor 6 input and output voltage can be detected on the side of the failed voltage detection unit 1A, and a fused closed contactor 6 can be detected.

As this invention may be embodied in several forms without departing from the spirit or the essential characteristics thereof, the present embodiment is therefore illustrative and not restrictive, since the scope of the invention is defined by the appended claims rather than by the description preceding them, and all changes that fall within the metes and bounds of the claims or the equivalence of such metes and bounds thereof are therefore intended to be embraced by the claims. This application is based on application No. 2004-199860 filed in Japan on Jul. 6, 2004, the content of which is incorporated hereinto by reference.

What is claimed is:

1. A car power source apparatus comprising a driving battery having a plurality of battery modules connected in series, contactors connected to the output side of the driving battery, a control circuit to control the contactors on and off, and a voltage detection circuit to detect voltage of the battery modules of the driving battery;
the control circuit is provided with a first output voltage detection circuit to detect contactor output voltage, and the voltage detection circuit is provided with a second output voltage detection circuit to detect contactor output voltage; wherein
the control circuit puts the contactors in the cut-off state, the first output voltage detection circuit of the control circuit detects output voltage to detect if a contactor is fused closed, if the first output voltage detection circuit of the control circuit cannot detect contactor output voltage, the second output voltage detection circuit of the voltage detection circuit detects contactor output voltage to detect if a contactor is fused closed.

2. A car power source apparatus as recited in claim 1 wherein the voltage detection circuit is provided with input voltage detection circuits to detect contactor input voltage.

3. A car power source apparatus as recited in claim 1 wherein the voltage detection circuit is provided with multiplexers to switch to, and detect voltage of a plurality of battery modules; and contactor outputs are connected to specified multiplexer channels to establish the second output voltage detection circuit for detecting contactor output voltage.

4. A car power source apparatus as recited in claim 3 wherein the voltage detection circuit is provided with 32 channel multiplexers, and contactor outputs are assigned to specified multiplexer channels to establish the second output voltage detection circuit for detecting contactor output voltage.

5. A car power source apparatus as recited in claim 2 wherein the voltage detection circuit is provided with multiplexers to switch to, and detect voltage of a plurality of battery modules; and contactor inputs and outputs are connected to specified multiplexer channels to establish input voltage detection circuits for detecting contactor input voltage and the second output voltage detection circuit for detecting contactor output voltage.

6. A car power source apparatus as recited in claim 5 wherein the voltage detection circuit is provided with 32 channel multiplexers, and contactor inputs and outputs are assigned to specified multiplexer channels to establish input voltage detection circuits for detecting contactor input voltage and the second output voltage detection circuit for detecting contactor output voltage.

7. A car power source apparatus as recited in claim 2 wherein the voltage detection circuit is provided with a plurality of voltage detection units, each voltage detection unit is provided with a second output voltage detection circuit for detecting contactor output voltage, and an input voltage detection circuit for detecting contactor input voltage; and each voltage detection unit detects contactor input and output voltage.

8. A car power source apparatus as recited in claim 7 wherein the voltage detection circuit is provided with two voltage detection units, and each voltage detection unit is provided with a second output voltage detection circuit for detecting contactor output voltage.

9. A car power source apparatus as recited in claim 7 wherein a voltage detection unit is provided with a multiplexer to switch to, and detect voltage of a plurality of battery modules; and contactor inputs and outputs are connected to specified multiplexer channels to detect contactor input and output voltage.

10. A car power source apparatus comprising a driving battery having a plurality of battery modules connected in series, contactors connected to the output side of the driving battery, a control circuit to control the contactors on and off, and a voltage detection circuit to detect voltage of the battery modules of the driving battery;
the driving battery is made up of a plurality of battery blocks, the voltage detection circuit is made up of a plurality of voltage detection units, voltage detection units are connected to battery blocks, and one voltage detection unit detects the voltage of battery modules that form one battery block;
each voltage detection unit is provided with a multiplexer to switch to the battery module for voltage detection and a voltage detection section to detect the voltage of the connection node switched to by the multiplexer, and the multiplexer switches battery modules to detect the voltage of each battery module; and
contactor outputs are connected to the input side of the multiplexer of each voltage detection unit, and each voltage detection unit detects contactor output voltage.

11. A car power source apparatus as recited in claim 10 wherein contactor inputs and outputs are connected to the input side of the multiplexer of each voltage detection unit, and each voltage detection unit detects contactor input and output voltage.

12. A car power source apparatus as recited in claim 11 wherein the driving battery is made up of two of battery blocks, the voltage detection circuit is made up of two of voltage detection units, voltage detection units are connected to battery blocks, and one voltage detection unit detects the voltage of battery modules that form one battery block

13. A car power source apparatus comprising a driving battery having a plurality of battery modules connected in series, and a voltage detection circuit to detect voltage of the battery modules of the driving battery;
the driving battery is made up of a plurality of battery blocks, the voltage detection circuit is made up of a plurality of voltage detection units, voltage detection units are connected to battery blocks, and one voltage detection unit detects the voltage of battery modules that form one battery block;
each voltage detection unit is provided with a multiplexer to switch to the battery module for voltage detection and a voltage detection section to detect the voltage of the connection node switched to by the multiplexer, and the multiplexer switches battery modules to detect the voltage of each battery module; and
driving battery outputs are connected to the input side of the multiplexer of each voltage detection unit, and each voltage detection unit detects the total voltage of the driving battery.

14. A car power source apparatus as recited in claim 13 wherein the driving battery is made up of two of battery blocks, the voltage detection circuit is made up of two of voltage detection units, voltage detection units are connected to battery blocks, and one voltage detection unit detects the voltage of battery modules that form one battery block.
